(19) United States
(12) Patent Application Publication
(10) Pub. No.: US 2013/0344988 A1
(43) Pub. Date: Dec. 26, 2013

(54) IRON-TYPE GOLF CLUB

(71) Applicants: Ronald K. Hettinger, Oceanside, CA (US); Uday V. Deshmukh, Carlsbad, CA (US); Keisuke Yamane, Laguna Niguel, CA (US); Daniel Stone, Long Beach, CA (US)

(72) Inventors: Ronald K. Hettinger, Oceanside, CA (US); Uday V. Deshmukh, Carlsbad, CA (US); Keisuke Yamane, Laguna Niguel, CA (US); Daniel Stone, Long Beach, CA (US)

(21) Appl. No.: 13/527,635

(22) Filed: Jun. 20, 2012

(51) Int. Cl. A63B 53/04; B21K 17/00; B23P 17/00

(52) U.S. Cl. 473/349; 29/428; 72/352

(57) ABSTRACT

An iron-type golf club including a golf club head having improved mass distribution characteristics. The golf club includes a golf club head that is constructed from multiple pieces and that has a multi-material construction.

### FIELD OF THE INVENTION

This invention generally relates to golf clubs, and more specifically to a golf club head having a multi-material construction.

### BACKGROUND OF THE INVENTION

Typical iron club heads are solid with flat hitting faces and generally configured as either muscle back or cavity back clubs. Traditionally, all irons were configured as muscle back clubs, which are smooth at the back with low offset, a thin topline and a thin sole, and a topline that has a thickness that is similar to the thickness of an upper blade portion of the clubs. Cavity back irons have a hollowed out back and the club head mass is redistributed to the sole and the perimeter of the club head, which moves the center of gravity lower to the ground and rearward. The weight distribution makes the iron launch the ball higher and increases rotational moment of inertia thereby lowering its tendency to rotate on mis-hits and enlarging the sweet spot.

Some muscle back irons have an interior hollow section, such that the club resembles a muscle back on the outside but the interior hollow section alters the club's mass characteristics. One example is U.S. Pat. No. 4,645,207 to Teramoto et al. The Teramoto patent discloses a set of iron golf clubs in which the iron club is cast by the lost wax method, and the back member is welded at the back of the face member to form a hollow section between the back and face members. As the club changes from a longer iron to a shorter iron, the hollow section is gradually decreased to zero and the sole width is gradually decreased.

Another example is U.S. Pat. No. 4,754,969 to Kobayashi. The Kobayashi patent discloses a set of golf clubs wherein each one-piece club head includes a hollow section behind the striking face. Each of the club heads is made of a stainless steel by, for example, a lost wax casting process. The material of each of the face portions of the club heads is then annealed.

Another example is U.S. Pat. No. 7,126,339 to Nagai et al., which discloses utility golf clubs, which generally include a hollow interior.

There remains a need in the art for an improved iron-type golf club that provides greater flexibility in manufacturing processes and materials while incorporating complicated geometries.

### SUMMARY OF THE INVENTION

The present invention is directed to iron-type golf clubs. The inventive iron-type golf club provides a club head that improves the discretionary mass placement to optimize the center of gravity location and moment of inertia values utilizing a multi-material construction, while providing more manufacturing flexibility.

In an embodiment, an iron-type golf club head includes a body, at least one body weight member and a hosel weight member. The body includes a body member and a sole member that is coupled to the body member along at least a portion of a perimeter of the sole member. The coupling forms an interface between the body member and the sole member. The body defines a lower cavity that includes an upper opening and that is entirely defined by the body member and the sole member, and the upper opening is defined by a flange, wherein a portion of the flange extends from a rear surface of a face of the body and overhangs a portion of the lower cavity. The lower surface of the sole member forms at least a portion of a sole surface of the golf club head. The body defines a receptacle that extends across the interface and at least one body weight member is coupled to the body in the receptacle. The lower surface of the body weight member forms a portion of the sole surface of the golf club head. The hosel weight member is coupled to a proximal end of a hosel of the body. The body comprises a first material and the body weight member comprises a material that has a specific gravity that is greater than a specific gravity of the first material, and the hosel weight member comprises a material that has a specific gravity that is greater than the specific gravity of the first material.

In another embodiment, an iron-type golf club head includes a body and a plurality of weight members. The body includes a body member and a sole member that is coupled to the body member along at least a portion of a perimeter of the sole member. The coupling forms an interface and a lower surface of the sole member forms at least a portion of a sole surface of the golf club head. The body defines a plurality of receptacles that extend across the interface. The plurality of weight members are coupled to the body in the receptacles and the lower surface of each weight member forms a portion of the sole surface of the golf club head. A portion of the sole member is sandwiched between a weight member and the body member.

The present invention also includes a method of constructing an iron-type golf club head. The method includes forming a pre-form body that has a perimeter weighted upper portion and a solid muscle back lower portion. An elongate slot is formed in the pre-form body and an elongate sole member is formed and coupled to the body member in the slot. At least one receptacle is formed across an interface between the body member and the sole member. At least one weight member is formed and coupled to the sole member and the body member in the receptacle.

### BRIEF DESCRIPTION OF THE DRAWINGS

In the accompanying drawings, which form a part of the specification and are to be read in conjunction therewith and in which like reference numerals are used to indicate like parts in the various views:

FIG. 1 is a perspective view of an iron-type golf club in accordance with the present invention,

FIG. 2 is a rear view of the golf club head of FIG. 1;

FIG. 3 is a cross-sectional view, taken along line 3-3, shown in FIG. 2;

FIG. 4 is an exploded view of the golf club head of FIG. 1;

FIG. 5 is another perspective view of the golf club head of FIG. 1;

FIG. 6 is a rear view of a pre-form of a body member of the golf club head of FIG. 1;

FIG. 7 is a rear view of the body member of the golf club head of FIG. 1;

FIG. 8 is a rear view of a sole member of the golf club head of FIG. 1;

FIG. 9 is a perspective view of the coupled body member and sole member of the golf club head of FIG. 1;

FIG. 10 is a perspective view of another embodiment of a golf club head;

FIG. 11 is a cross-sectional view, taken along line 11-11, shown in FIG. 10;

FIG. 12 is a cross-sectional view, taken along line 12-12, shown in FIG. 10;

FIG. 13 is a cross-sectional view, taken along line 13-13, shown in FIG. 10;

FIG. 14 is an exploded view of the golf club head of FIG. 10;

FIG. 15 is an exploded view of another embodiment of the golf club head;

FIG. 16 is a perspective view of another embodiment of a golf club head;

FIG. 17 is a perspective view of a further embodiment of a golf club head;

FIG. 18 is a perspective view of still further embodiment of a golf club head;

FIG. 19 is a perspective view of another embodiment of a golf club head;

FIG. 20 is a perspective view of another embodiment of a golf club head; and

FIG. 21 is a schematic illustrating the dimensions of a golf club head.

### DETAILED DESCRIPTION OF THE PREFERRED EMBODIMENTS

The present invention is directed to golf clubs having heads that include multi-material construction. The inventive construction utilizes golf club heads constructed of at least three different metallic materials, with one of the materials interposed between two others. Several embodiments of the present invention are described below.

Other than in the operating examples, or unless otherwise expressly specified, all of the numerical ranges, amounts, values and percentages such as those for amounts of materials, moments of inertias, center of gravity locations, loft and draft angles, and others in the following portion of the specification may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

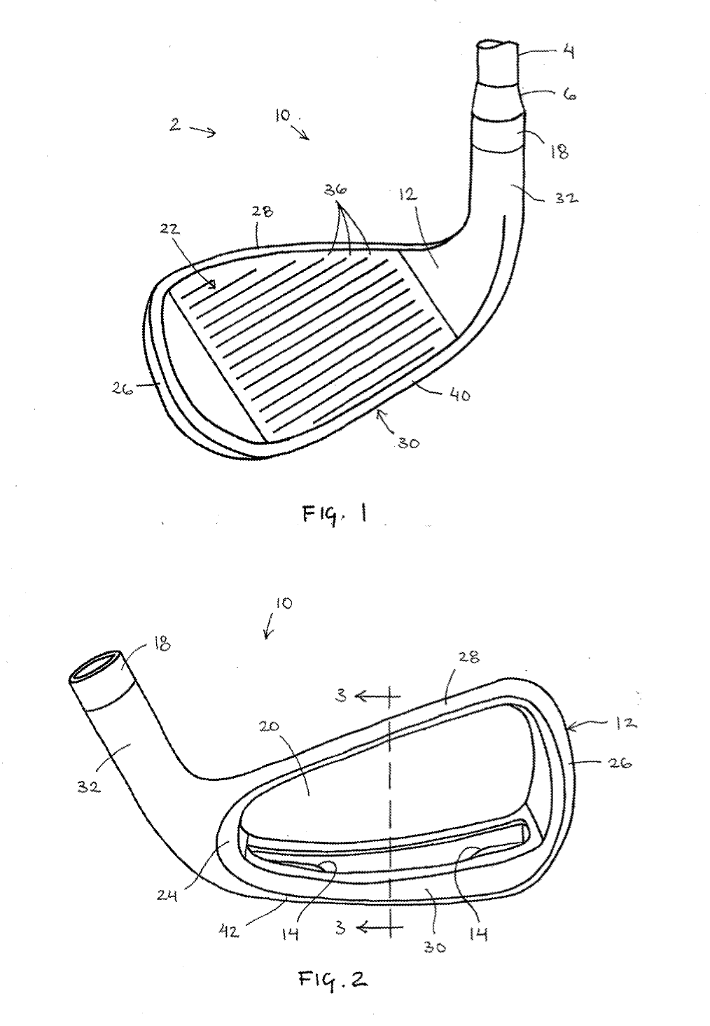

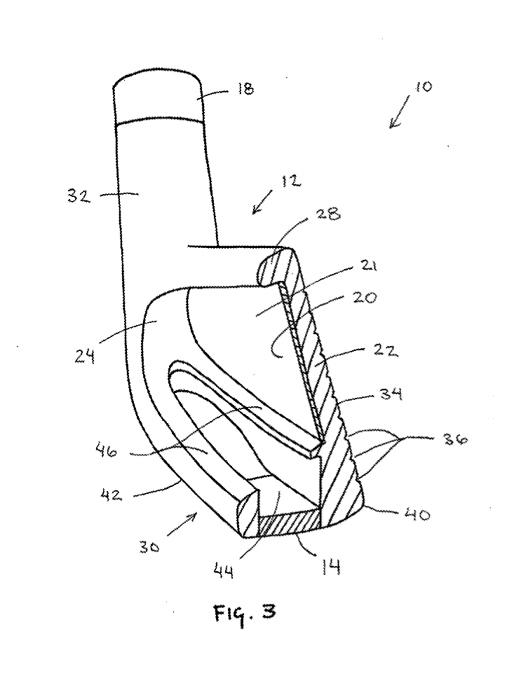

Referring to FIGS. 1-4, a golf club 2 includes a shaft 4, a ferrule 6, a grip (not shown) and a golf club head 10. Golf club head 10 includes a club head body member 12, a sole member 14, a plurality of body weight members 16, a hosel weight 18 and a back plate 20. Body member 12 generally has an upper, perimeter weighted portion that defines an upper cavity 21 that is opened rearward, and a lower muscle portion. Body member 12 includes a face 22, a heel perimeter weight portion 24, a toe perimeter weight portion 26, a topline 28, a sole portion 30 and a hosel 32. Face 22 extends between topline 28, a leading edge 40 disposed at the junction of face 22 and sole portion 30, heel perimeter weight portion 24, and toe perimeter weight portion 26. Face 22 defines a ball striking surface 34, a plurality of grooves 36, and a rear surface 38 that is coupled to back plate 20.

Sole portion 30 of body member 12 extends between leading edge 40 and a trailing edge 42 in a fore/aft direction and between the heel and toe of club head 10. The sole surface of golf club head 10 is provided by a combination of the lower surfaces of sole portion 30, sole member 14, and body weight members 16. In particular, a lower surface of sole member 14 forms a central, elongate portion of the sole surface of golf club head 10 and lower surfaces of body weight members 16 form central portions at the heel and toe ends of the sole surface of golf club head 10.

Sole member 14 is included in golf club head 10 and simplifies the construction of the golf club head so that a wider selection of manufacturing processes are available for constructing golf club head 10. In particular, in an example, body member 12 may be constructed from a forged material even with the construction of golf club head 10 that includes a lower cavity 44 that is defined by sole portion 30 of body member 12 and sole member 14. Lower cavity 44 includes an upper opening, defined by a flange 46 of body member 12, so that lower cavity is opened to upper cavity 21.

Flange 46 is formed as an integral portion of body member 12 and a portion of flange 46 overhangs lower cavity 44. As shown in FIG. 3, a forward portion of flange 46 extends rearward from face 22, and further rearward relative to the portions of face 22 above and below flange 46, so that it is cantilevered from face 22. The underside of flange 46 may be machined from the bottom of body member 12 by including a lower opening that is closed by sole member 14. As a result of that construction, the shape of the lower cavity 44 may have a more detailed and precise configuration, such as being undercut with flange 46 overhanging at least a portion of the cavity.

The lower end of lower cavity 44 is closed by sole member 14. As a result, lower cavity 44 is an opened cavity that is fully defined by body member 12 and sole member 14. Preferably, the body member 12 and sole member 14 are constructed from the same material so that they may be easily coupled, such as by welding.

Body weight members 16 are disposed at the heel and toe ends of club head 10. In the present embodiment, each of weight members 16 is constructed with a material that has a higher specific gravity than that of both body member 12 and sole member 14. For example, body weight members 16 may be constructed from a material such as tungsten or a tungsten nickel alloy and brazed into receptacles formed in a steel body member 12 and sole member 14. Alternatively, a lower density alloy that still has a higher specific gravity than the material of body member 12 and sole member 14, such as a 10 g/cc density tungsten alloy, may be utilized for body weight members 16 so that they may be welded into the receptacles. Combinations of different density weight members may also be incorporated.

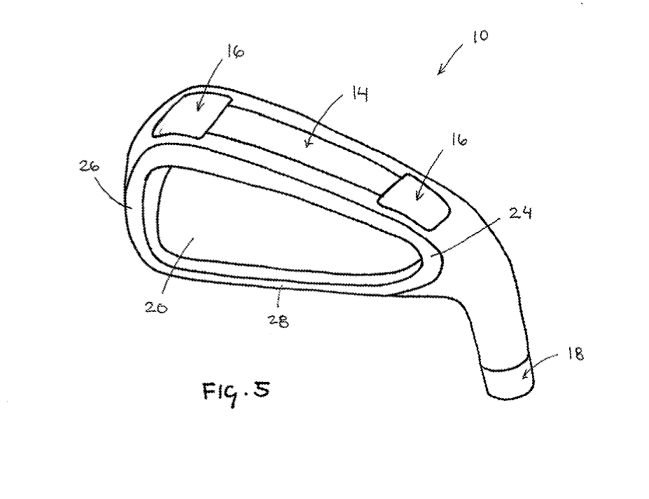

Golf club head 10 also includes hosel weight 18. Hosel weight 18 is coupled to hosel 32 of body member 12. Hosel weight 18 may be a member that is coupled to a proximal end of hosel 32 so that it replaces a portion of the hosel, as shown, or the hosel weight may be constructed as a weight plug that is coupled to body member 12 inside, or below, a shaft bore of hosel 32. Preferably, hosel weight 18 is constructed from a material that has a higher specific gravity than the material of body member 12 and it may be weldable, brazed or mechanically coupled to body member 12. For example, body member 12 may be constructed from steel and hosel weight 18 may be constructed of a 10 g/cc tungsten alloy that is welded to the proximal end of hosel 32, as shown in FIGS. 1-5. Alternatively, portions of the hosel weight and the body member may be threaded and complementary so that they may be mechanically coupled. As further alternatives, the hosel weight and body member may be swaged together or press, or interference, fit together.

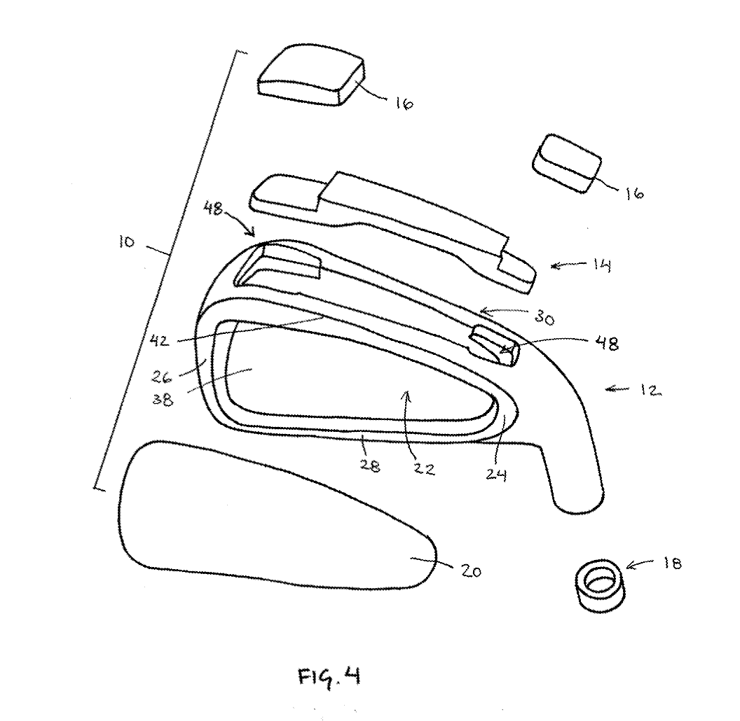

As shown in FIG. 4, a receptacle 48 is formed in body member 12 and sole member 14 for each weight member 16. Each receptacle 48 is formed partially in each of body member 12 and sole member 14 so that each weight member 16 is coupled to both body member 12 and sole member 14 after weight members 16 are installed.

Back plate 20 is coupled to rear surface 38 of face 22 and covers a portion of rear surface 38 that is disposed between topline 28 and flange 46 of body member 12. Preferably, back plate 20 is spaced from the upper opening into lower cavity 44 so that back plate 20 does not close any portion of lower cavity 44. Back plate 20 is coupled to rear surface 38, such as by adhesive, and may be used to tune the final weight and/or to alter the vibration characteristics of the completed golf club head 10.

Referring now to FIGS. 6-9, a process for making golf club head 10 will be described. The construction of body member 12 starts with a forged pre-form 52 that has a cavity back construction with a solid perimeter weight portion 54 and no lower cavity in a sole portion 56 of the perimeter weight portion 54, as shown in FIG. 6. The limitations of the forging process limit the features that are able to be included in pre-form 52 and the shapes of various parts. For example, because the forging process depends upon pressing a tool having a positive profile into a heated material and then retracting the tool, the features that may be included are generally limited. In particular, draft angles must generally included on recesses and cavities and it is very difficult to make undercut features without requiring intricate tooling and/or the re-orientation of the pre-form as an intermediate step in the process. As an alternative, the body member, including the lower cavity, may be cast using an investment casting process.

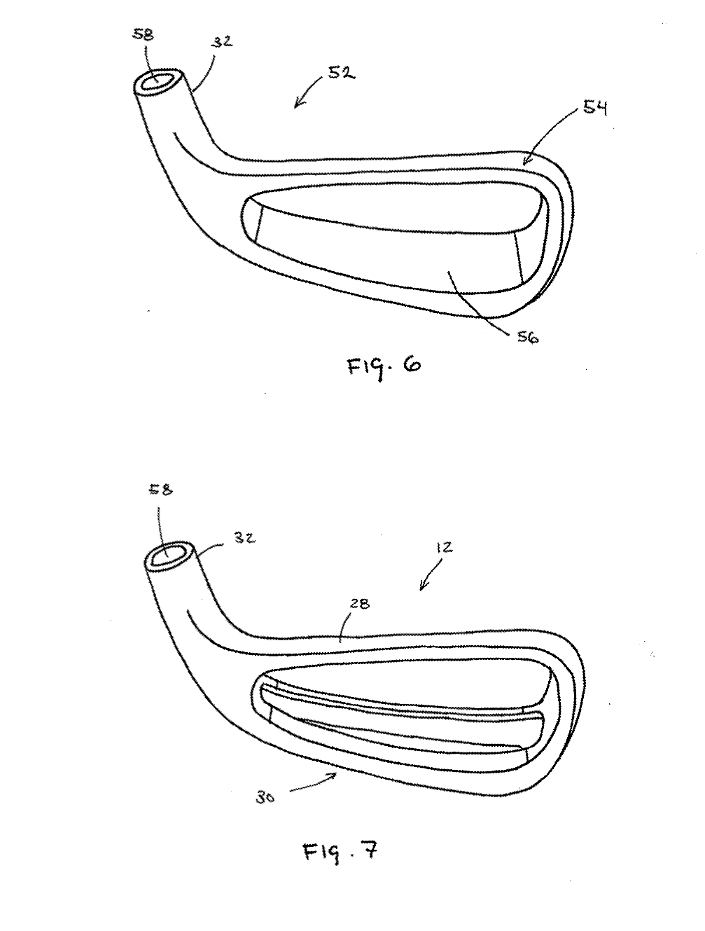

After pre-form 52 is created, a machining process is performed to create the geometry of lower cavity 44 in the sole portion 56 of pre-form 52, shown in FIG. 7, and to create a hosel bore 58. Because lower cavity 44 of golf club head 10 includes an undercut below flange 46, pre-form 52 is preferably machined from the sole side to create lower cavity 44. After the machining process, the machined sole portion 56 includes both an upper opening and a lower opening. Flange 46 is formed by the machining process and defines the upper opening of lower cavity 44. As stated above, rather than using a forged pre-form and machining the lower cavity, the body member, including the lower cavity, may be cast.

The machining process is preferably performed by extending a machine tool into sole portion 56 from the sole surface side. For example, using a mill, and removing an elongate portion of sole portion 56 to create a cavity. The depth of the machine tool may vary throughout the cavity to create the overhanging flange 46 and the upper opening. For example, the machine tool is extended into, and through, sole portion 56 to create the upper opening, and the machine tool is extended only partially into sole portion 56 to cut the underside of flange 46. The machining of the lower cavity and the hosel bore result in the construction of the body member 12.

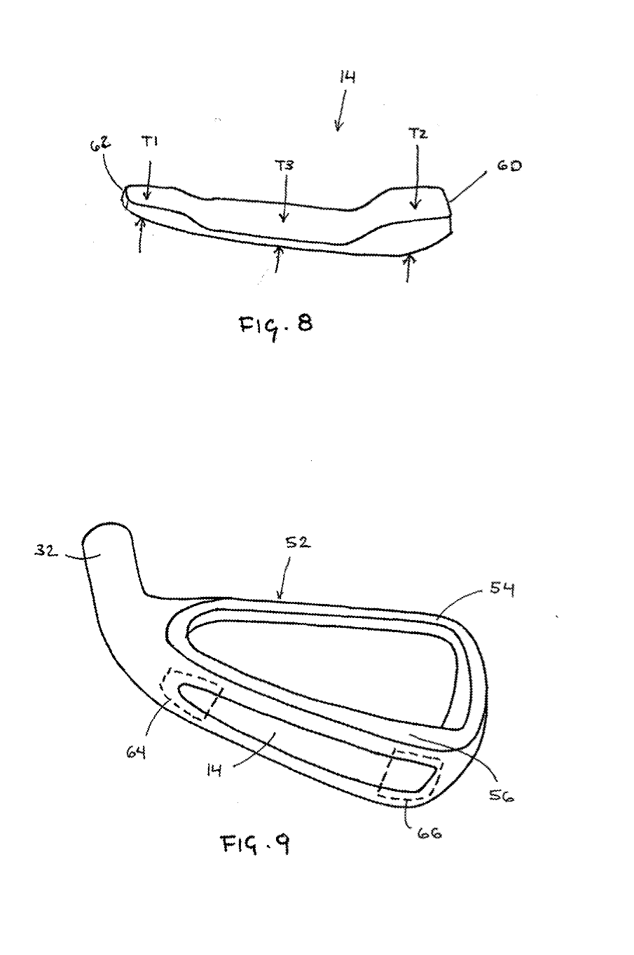

A separate sole member 14 is constructed and is coupled to body member 12, illustrated in FIG. 7, to close the lower opening that is created by machining the lower cavity. Sole member 14 includes portions having different thicknesses. The thicknesses are selected to provide portions that can be machined, after sole member 14 is coupled to body member 12, to create receptacles for weight members 16. In the example shown in FIG. 8, end portions of the elongate sole member 14, adjacent a toe end 60 and a heel end 62 of the sole member, have thicknesses T1 and T2 that are greater than a thickness T3 at the center of sole member 14. That thickness configuration is provided for a golf club head that includes weight members 16 at the heel and toe of the golf club head, such as golf club head 10. Alternative thickness configurations may be provided for different weight configurations. For example, in a golf club head that includes a weight member located in the center of the sole, a sole member having a greater thickness in the center compared to the heel and toe ends may be provided. Sole member 14 is preferably constructed as a forged component constructed from the same material as pre-form 52. It should be appreciated, however, that sole member 14 may be forged, stamped, cast, machined, or made with any other manufacturing process and it may be constructed from a material that is different than the body member, if desired.

Sole member 14 is shaped to fit inside the lower opening of the lower cavity, and is coupled to body member 12 so that the lower opening is closed, as shown in FIG. 9. Sole member 14 is preferably coupled to body member 12 by welding. It should be appreciated, that the process for coupling sole member to body member 12 may be altered to suit the materials of the sole member and the pre-form, for example, the pieces may be brazed, welded, swaged or otherwise mechanically coupled together.

After sole member 14 is mounted in body member 12, receptacles are preferably machined into the sole. As shown by the exploded view of FIG. 4, and the dashed lines in FIG. 9, the receptacles are machined in the body so that they extend across an interface between sole member 14 and body member 12 and include a heel receptacle 64 and a toe receptacle 66. After the receptacles are created, the steps of installing weight members 16, hosel weight 18, and back plate 20 are performed to create the complete golf club head 10.

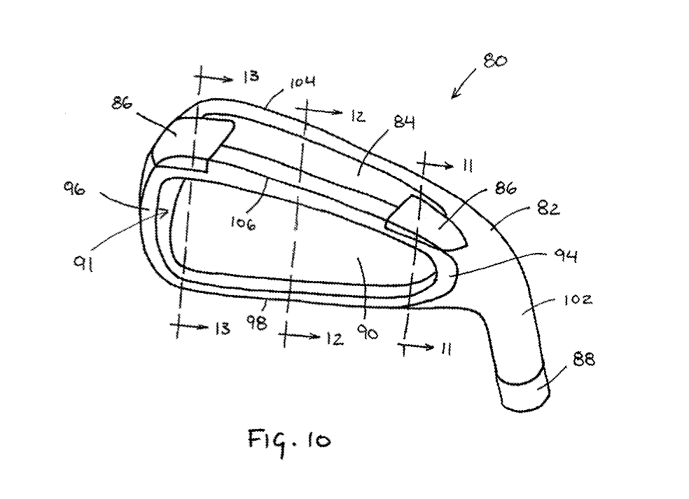

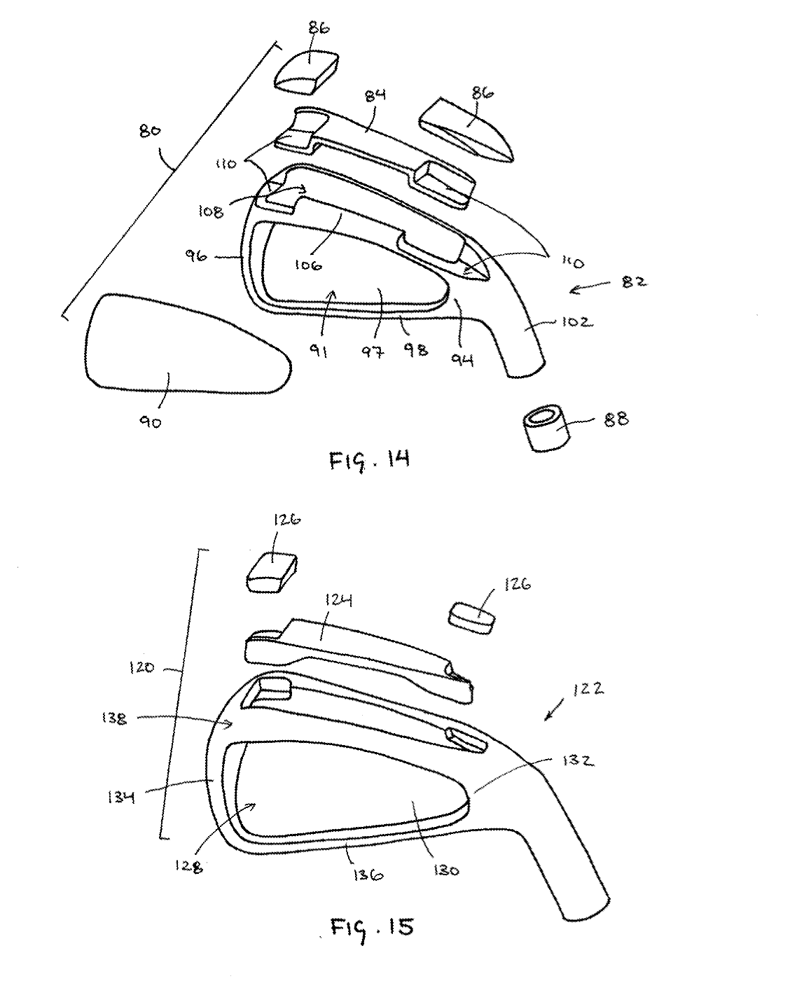

Referring now to FIGS. 10-14, another embodiment of a golf club head will be described. Golf club head 80 includes a club head body member 82, a sole member 84, a plurality of body weight members 86, a hosel weight 88 and a back plate 90. Body member 82 generally has an upper, perimeter weighted portion that defines a upper cavity 91, and that includes a face 92, a heel perimeter weight portion 94, a toe perimeter weight portion 96, a topline 98, a sole portion 100 and a hosel 102. Face 92 extends between topline 98, a leading edge 104 disposed at the junction of face 92 and sole portion 100, heel perimeter weight portion 94, and toe perimeter weight portion 96. Face 92 defines a ball striking surface 93, a plurality of grooves 95, and a rear surface 97 that is coupled to back plate 90.

Sole portion 100 of body member 92 extends between leading edge 104 and a trailing edge 106 in a fore/aft direction and between the heel and toe of club head 80. The sole surface of golf club head 80 is provided by a combination of the lower surfaces of sole portion 100 of body member 82, sole member 84, and body weight members 86. Weight members 86 are located further aftward in sole portion 100, as compared to the golf club head 10, so lower surfaces of body weight members 86 form aft portions of the sole surface of golf club head 80 at the heel and toe ends of the sole surface.

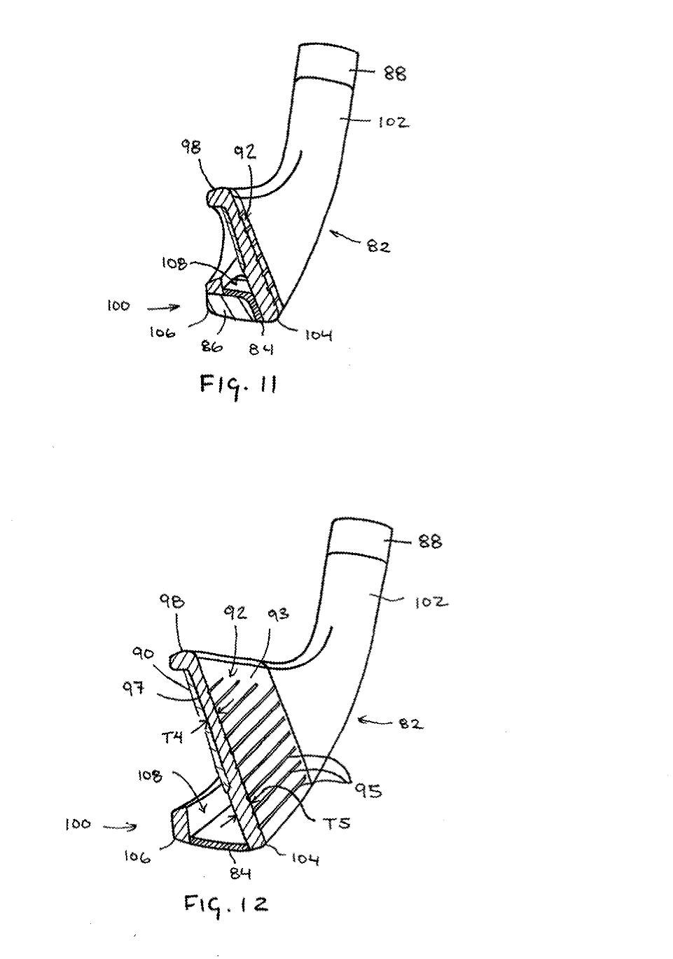

Body member 82 is preferably constructed from a forged material and golf club head 80 includes a lower cavity 108 that is defined by sole portion 100 of body member 82. Lower cavity 108 includes an upper opening so that lower cavity is opened to upper cavity 91, but does not include an overhanging flange. In the present embodiment, lower cavity 108 is shaped so that face 92 has portions with different thicknesses. For example, an upper portion of face 92 adjacent upper cavity 91 has a first thickness T4 that is different than a thickness T5 of a lower portion of face 92 adjacent lower cavity 108. As shown in FIG. 12, thickness T5 of the lower portion may be greater than thickness T4 of the upper portion. Alternatively, the thickness of the lower portion may be less than the thickness of the upper portion. Sole member 84 is coupled to body member 82 and closes the lower end of lower cavity 108.

Body weight members 86 are disposed at the heel and toe ends of club head 80, intersect trailing edge 106 and are spaced from leading edge 104. A portion of sole member 84 is sandwiched between weight member 86 and face 92. Each of weight members 86 is constructed with a material that has a higher specific gravity than that of both body member 82 and sole member 84. For example, body weight members 86 may be constructed from a material such as tungsten and brazed into pockets formed in a steel body member 82 and sole member 84. Alternatively, a lower density alloy may be utilized that still has a specific gravity that is greater than the material of the body member, such as a 10 g/cc density tungsten alloy, may be utilized for body weight members 86 so that they may be welded into pockets in the steel body member 82 and sole member 84.

Golf club head 80 also includes hosel weight 88. Hosel weight 88 is coupled to hosel 102 of body member 82 and is constructed from a material that has a higher specific gravity than the material of body member 82. Hosel weight 88 may be a generally annular member that is coupled to a proximal end of hosel 102, as shown, or the hosel weight may be constructed as a weight plug that is coupled to body member 82 inside a shaft bore of hosel 102.

The construction of golf club head 80 is similar to that of golf club head 10. In particular, a pre-form is constructed, preferably by forging, that includes a solid sole portion. The lower cavity is then machined into the sole portion so that it includes both upper and lower openings, and a hosel bore is machined into the pre-form resulting in the construction of body member 82. Sole member 84 is coupled to body member 82 so that it closes the lower opening of the lower cavity, thereby completing the construction of lower cavity 108 and the body of golf club head 80. Next, receptacles 110 are machined into the sole. Receptacles 110 are machined so that they extend across an interface between sole member 84 and body member 82 and include a heel receptacle and a toe receptacle. After receptacles 110 are created, the steps of installing weight members 86, hosel weight 88, and back plate 90 are performed to create the complete golf club head 80.

In the present embodiment, weight members 86 are positioned at the aft edge of sole surface, i.e., the trailing edge, so that the mass of weight members is located as far aftward as possible. Each receptacle 110 is formed partially in each of body member 82 and sole member 84 so that each weight member 86 is coupled to both body member 82 and sole member 84 after weight members 86 are installed.

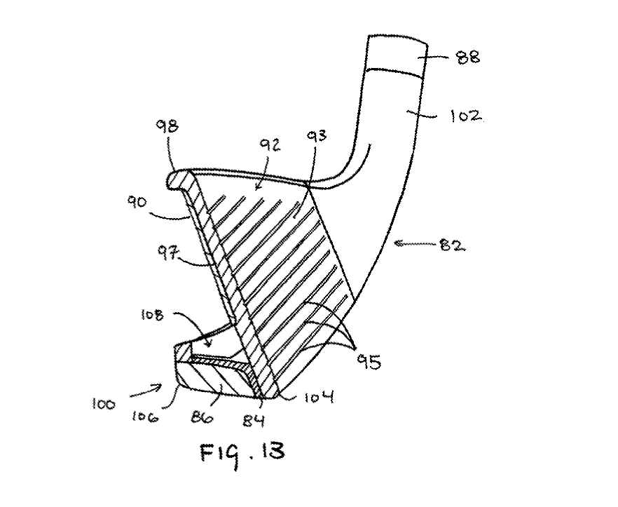

As illustrated in FIG. 11, the heel receptacle 110 and the heel weight intersect a portion of trailing edge 106 and a portion of sole member 84 is sandwiched between a forward surface of the heel weight member and face 92. At the center of golf club 80, there is no weight member so sole member 84 is interposed between portions of body member 82 to close a lower end of lower cavity 108, and as a result, a lower surface of sole member 84 forms the central sole surface of golf club head 80, as shown in FIG. 12. The toe weight member is located similarly to the heel weight member. In particular, the toe receptacle 110 and the toe weight intersect a portion of trailing edge 106 and a portion of sole member 84 is sandwiched between a forward surface of the toe weight member and face 92, as shown in FIG. 13.

Back plate 90 is coupled to rear surface 97 of face 92 and covers a portion of rear surface 97 that is disposed between topline 98 and lower cavity 108. Back plate 90 is coupled to rear surface 97, such as by adhesive, and may be used to tune the final weight and/or to alter the vibration characteristics of the completed golf club head 80. Back plate 90 may also extend into lower cavity 108 so that it covers a larger portion of a rear surface of the face.

A golf club head similar to golf club head 80 having alternative body weight locations will be described with reference to FIG. 15. Golf club head 120 includes a club head body member 122, a sole member 124 and a plurality of body weight members 126. Body member 122 generally has an upper, perimeter weighted construction. Body member defines an upper cavity 128, and that includes a face 130, a heel perimeter weight portion 132, a toe perimeter weight portion 134, a topline 136, a sole portion 138 and a hosel 140.

Sole portion 138 of body member 122 extends between a leading edge 142 and a trailing edge 144 in a fore/aft direction and between the heel and toe of club head 120. The sole surface of golf club head 120 is provided by a combination of the lower surfaces of sole portion 138 of body member 122, sole member 124, and body weight members 126.

Receptacles 146 are formed in body member 122 and sole member 124 for weight members 126 after sole member 124 is coupled to body member 122. Each receptacle 146 is formed partially in each of body member 128 and sole member 124 so that each weight member 126 is coupled to both body member 122 and sole member 124 after weight members 126 are installed.

Weight members 126 are located further forward, toward a ball-striking face, than previous embodiments. In the present embodiment, weight members 126 are spaced from both leading edge 142 and trailing edge, but a portion of sole member 124 is sandwiched between an aftward surface of the weight member and an aft portion of sole portion 138 of body member 122.

Referring now to FIGS. 16-20, embodiments of the golf club head of the present invention will be described. The illustrated embodiments illustrate alternative weight member placement. The illustrated embodiments illustrate that the use of various combinations of weights allow the manipulation and optimization of the center of gravity (CG) location relative to the CG location and the shaft axis, and the moment of inertia (MOI) values of the golf club head about each of the coordinate axes extending through the CG location as well as about the shaft axis. Primarily, configurations of a golf club head including a hosel weight, a heel weight and a toe weight are utilized to alter the CG and MOI values. Secondarily, the blade length, hosel length and body density may be used to alter the CG and MOI values. Although, all of the illustrated embodiments incorporate the inventive structures in 4-iron constructions, it should be appreciated that the constructions may be applied, and varied, throughout an iron set, such as by selecting different materials for the body members and/or weight members and by selecting different sizes for the weight members and overall dimensions of the golf club heads. For example, a mid-density material may be utilized for the body members of longer irons in a set and a higher density material may be utilized for body members of shorter irons in the set.

With the exception of the weight member construction and placement, each of the embodiments of FIGS. 16-20 generally have identical characteristics. In particular, each golf club head includes an upper blade portion, a lower cavity portion and a plurality of weights. The upper blade portion is a non-perimeter weighted portion that generally has approximately equal thickness throughout. The lower perimeter weighted portion includes a cavity defined by a thicker perimeter portion. Additionally, each of the embodiments is constructed using generally the same process which includes forging or casting a body pre-form. The receptacles may be included in the initial forging or casting, or machined into the pre-form. Finally the weight members are coupled in the receptacles using processes that are appropriate for the material, for example, the higher density tungsten weight members will generally be brazed or mechanically coupled to the remainder of the golf club head and the lower density tungsten alloy weight members will generally be brazed, mechanically coupled or welded to the remainder of the golf club head, which will generally be constructed of steel (carbon or stainless). Generally, the various weight members are constructed from tungsten nickel alloys that have density ranging from about 10 g/cc to about 19 g/cc. Additionally the body member may be constructed of mid-density alloys that have densities that are between those of aluminum, at about 6 g/cc, and steel, at about 8 g/cc.

Properties of 4-irons, i.e., iron-type golf clubs having a loft of 22° and a lie angle of 61°, having constructions shown in the examples illustrated in FIGS. 16-20 are provided in Table 1. Table 1 also includes values for comparative examples 1 and 2 that correspond to traditional muscle-back and cavity-back irons, respectively, such as Titleist (a registered trademark of the Acushnet Company, Fairhaven, Mass.) 710 MB and 710 CB irons.

In a first example, illustrated in FIG. 16, a golf club head 150 includes a body member 152 and a plurality of weight members 154. Body member 152 includes an upper blade portion 156 and a lower cavity portion 158. Weight members 154 are disposed in low heel and low toe regions of body member 152. In this example, body member 152 is constructed from a 7 g/cc aluminum-iron alloy, the heel weight member 154 is constructed of 17 g/cc tungsten, and the toe weight member 154 is constructed of a 12 g/cc tungsten alloy.

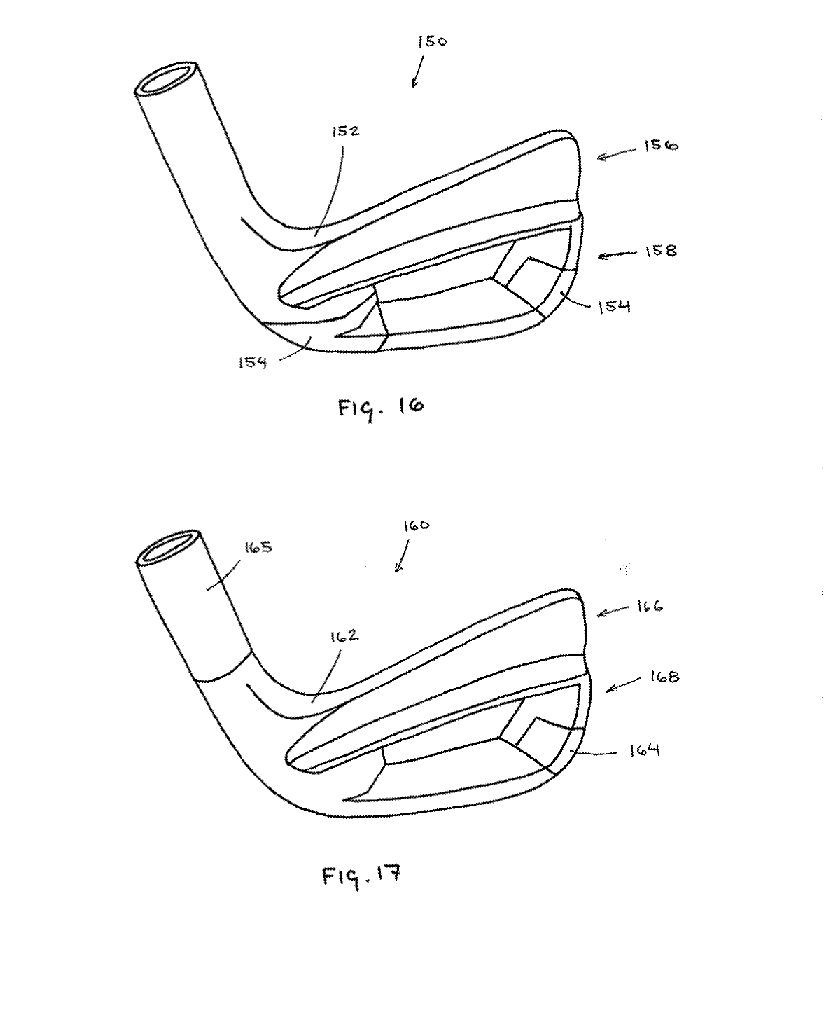

In a second example, illustrated in FIG. 17, a golf club head 160 includes a body member 162, a body weight member 164 and a hosel weight member 165. Body member 162 includes an upper blade portion 166 and a lower cavity portion 168. Body weight member 164 is disposed in a low toe region of body member 162 and hosel weight member 165 replaces an upper portion of a hosel of body member 162. In this example, body member 162 is constructed from a 7 g/cc aluminum-iron alloy, body weight member 164 is constructed of a 12 g/cc tungsten alloy, and hosel weight member 165 is constructed of 17 g/cc tungsten.

Hosel weight member 165 is generally constructed as a solid cylindrical member that is coupled to a hosel portion of body member 165. The parts may be coupled by welding (such as conventional welding or friction welding), brazing, or mechanical couplings (such as threaded interfaces or press fitting), as appropriate for the material. After the parts are coupled, a bore is machined into the hosel weight and the hosel portion.

In a third example, illustrated in FIG. 18, a golf club head 170 includes a body member 172, a body weight member 174 and a hosel weight member 175. Body member 172 includes an upper blade portion 176 and a lower cavity portion 178. Body weight member 174 is disposed in a low toe region of body member 172 and hosel weight member 175 replaces middle portion of a hosel of body member 172 that is generally at a transition between the hosel and the remainder of the body member, i.e., the upper blade portion and the lower cavity back portion of body member 172. In this example, body member 172 is constructed from a 7 g/cc aluminum-iron alloy, body weight member 174 is constructed of a 12 g/cc tungsten alloy, and hosel weight member 175 is constructed of a 10 g/cc tungsten alloy.

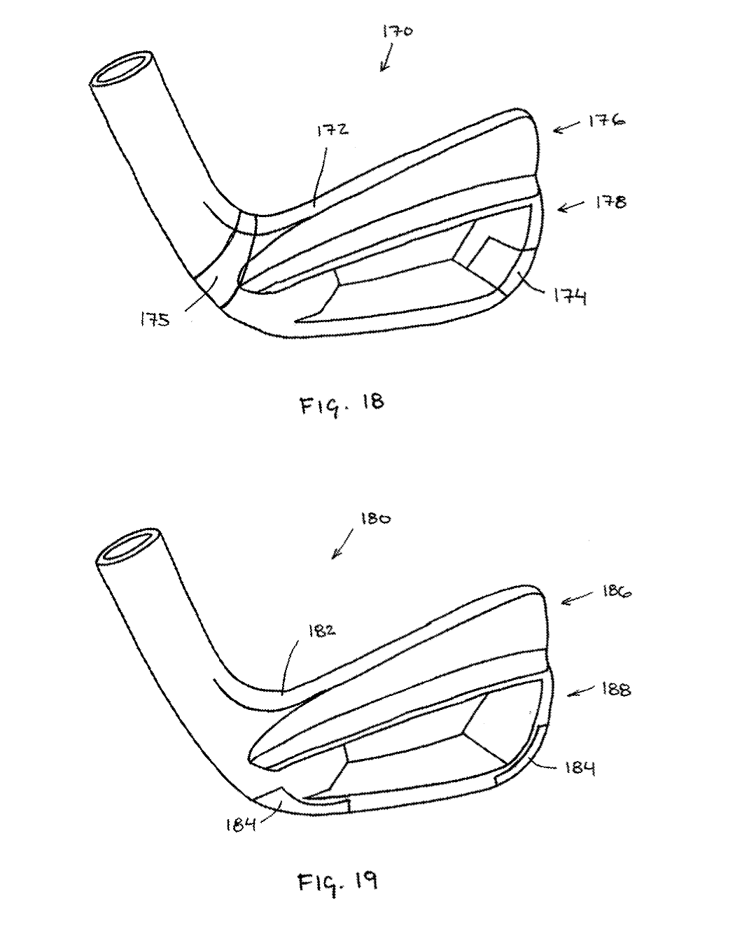

In a fourth example, illustrated in FIG. 19, a golf club head 180 includes a body member 182, and a plurality of body weight members 184. Body member 182 includes an upper blade portion 186 and a lower cavity portion 188. Body weight members 184 are disposed in a low heel region and a low toe region of body member 182. In this example, body member 182 is constructed from a 7 g/cc aluminum-iron alloy, the toe body weight member 184 is constructed of a 12 g/cc tungsten alloy, and the heel body weight member 184 is constructed of 17 g/cc tungsten.

In a fifth example, illustrated in FIG. 20, a golf club head 190 includes a body member 192, a plurality body weight members 194 and a hosel weight member 195. Body member 192 includes an upper blade portion 196 and a lower cavity portion 198. Body weight members 194 are disposed in a low toe and low heel regions of body member 192 and they are spaced from the rear cavity of body member 192. Hosel weight member 195 replaces an upper portion of a hosel of body member 192. In this example, body member 192 is constructed from a 7 g/cc aluminum-iron alloy, the toe body weight member 194 is constructed of a 12 g/cc tungsten alloy, the heel body weight member 194 is constructed of a 14 g/cc tungsten alloy, and hosel weight member 195 is constructed of a 16 g/cc tungsten alloy.

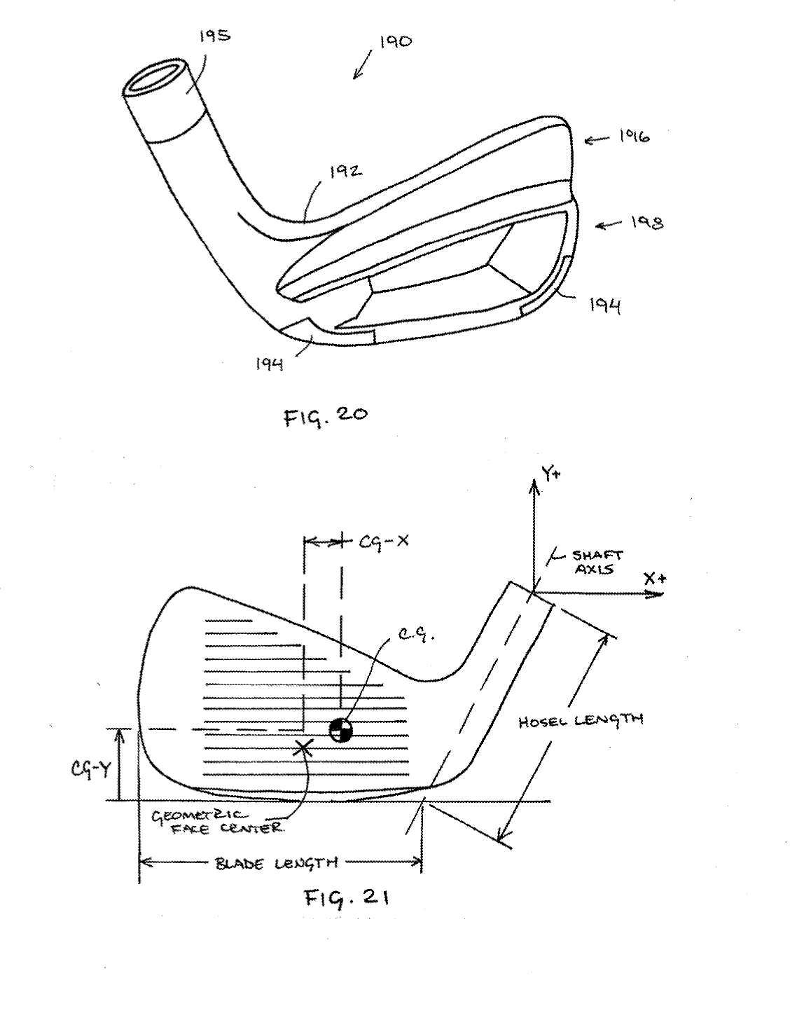

As illustrated in Table 1, a comparison between 4-irons of known golf club irons, shown as comparative examples 1 and 2, are compared to examples of golf club heads of the present invention. The dimensions that are included correspond to the measurements that are shown in the schematic of FIG. 21. In the table, the values for MOI-Y correspond to MOI about an axis parallel to the Y-axis, shown in the schematic of FIG. 21, that extends through the center of gravity of the golf club head. As shown by the examples, the constructions of the golf club heads of the present invention may be used to alter the location of the center of gravity relative to the geometric face center of the golf club head, while also altering the moment of inertia. Those adjustments allow the golf club head to be fine-tuned to match the needs of users for playability and forgiveness.

TABLE 1

| | | | | Hosel | Blade |
|---|---|---|---|---|---|
| | CG-X | CG-Y | MOI-Y | Length | Length |
| | [mm] | [mm] | [kgmm²] | [mm] | [mm] |
| Comp. Example 1 | 2.9 | 19.2 | 205 | 68.5 | 74.68 |
| Comp. Example 2 | 1.8 | 18.52 | 211 | 63 | 76.20 |
| Example 1 | 2.89 | 18.61 | 219 | 66 | 76.71 |
| Example 2 | 1.45 | 19.84 | 259 | 66 | 76.71 |
| Example 3 | 1.91 | 19.85 | 237 | 66 | 76.71 |
| Example 4 | 2.03 | 18.36 | 214 | 66 | 76.71 |
| Example 5 | 2.78 | 19.47 | 230 | 66 | 76.71 |

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

We claim:

1. An iron-type golf club head, comprising:
a body including a body member and a sole member, wherein the sole member is coupled to the body member along at least a portion of a perimeter of the sole member to form an interface, wherein a lower surface of the sole member forms at least a portion of a sole surface of the golf club head, wherein the body defines a receptacle that extends across the interface;
at least one body weight member coupled to the body in the receptacle, wherein the lower surface of the body weight member forms a portion of the sole surface of the golf club head; and
a hosel weight member coupled to a proximal end of a hosel of the body.
wherein the body defines a lower cavity that includes an upper opening and is entirely defined by the body member and the sole member
wherein the upper opening is defined by a flange, wherein a portion of the flange extends from a rear surface of a face of the body and overhangs a portion of the lower cavity, and
wherein the body comprises a first material and the body weight member comprises a material that has a specific gravity that is greater than a specific gravity of the first material, and the hosel weight member comprises a material that has a specific gravity that is greater than the specific gravity of the first material.

2. The iron-type golf club head of claim 1, wherein the sole member is an elongate body and includes a first portion having a first thickness and a second portion having a second thickness that is greater than the first thickness.

3. The iron-type golf club head of claim 1, wherein the sole member is an elongate body and includes a toe portion, a central portion and a heel portion, wherein the central portion has a first thickness and the toe portion and heel portion each have a thickness that is greater than the first thickness.

4. The iron-type golf club head of claim 1, wherein a portion of the sole member is sandwiched between a weight member and the body member.

5. The iron-type golf club head of claim 4, wherein the sole member is sandwiched between the weight member and the body member aftward of the weight member.

6. The iron-type golf club head of claim 4, wherein the sole member is sandwiched between the weight member and the body member forward of the weight member.

7. An iron-type golf club head, comprising:
a body including a body member and a sole member, wherein the sole member is coupled to the body member along at least a portion of a perimeter of the sole member to form an interface, wherein a lower surface of the sole member forms at least a portion of a sole surface of the golf club head, wherein the body defines a plurality of receptacles that extend across the interface; and
a plurality of weight members coupled to the body in the receptacles, wherein the lower surface of each weight member forms a portion of the sole surface of the golf club head,
wherein a portion of the sole member is sandwiched between a weight member and the body member.

8. The iron-type golf club head of claim 7, further comprising a hosel weight coupled to a proximal end of a hosel of the body.

9. The iron-type golf club head of claim 7, wherein the body defines a lower cavity that includes an upper opening and is entirely defined by the body member and the sole member.

10. The iron-type golf club head of claim 9, wherein the upper opening is defined by a flange, wherein a portion of the flange extends from a rear surface of a face of the body and overhangs a portion of the lower cavity.

11. The iron-type golf club head of claim 7, wherein the sole member is an elongate body and includes a first portion having a first thickness and a second portion having a second thickness that is greater than the first thickness.

12. The iron-type golf club head of claim 7, wherein the sole member is an elongate body and includes a toe portion, a central portion and a heel portion, wherein the central portion has a first thickness and the toe portion and heel portion each have a thickness that is greater than the first thickness.

13. The iron-type golf club head of claim 7, wherein the sole member is sandwiched between the weight member and the body member aftward of the weight member.

14. The iron-type golf club head of claim 7, wherein the sole member is sandwiched between the weight member and the body member forward of the weight member.

15. An method of constructing an iron-type golf club head, comprising:
forming a pre-form body, wherein the pre-form body has a perimeter weighted upper portion and a solid muscle back lower portion;
forming an elongate slot in a sole portion of the pre-form body to form a body member;
forming an elongate sole member;
coupling the elongate sole member to the body member in the elongate slot;
forming at least one receptacle that extends across an interface between the body member and the sole member;
forming at least one weight member; and
coupling the weight member to the sole member and the body member in the receptacle.

16. The method of claim 15, wherein the step of forming the pre-form body includes forging the pre-form body.

17. The method of claim 15, wherein the step of forming the elongate sole member includes forming the sole member so that a first portion of the sole member has a first thickness and a second portion of the sole member has a second thickness that is greater than the first thickness.

18. The method of claim 15, wherein the step of forming at least one receptacle includes machining a plurality of receptacles.

19. The method of claim 18, wherein one receptacle is disposed toward the toe relative to a second receptacle.
